(19) United States
(12) Patent Application Publication
(10) Pub. No.: US 2003/0209069 A1
(43) Pub. Date: Nov. 13, 2003

(54) Chemical bath having liquid level indications in outer trough

(75) Inventors: Hsuan-Sheng Tung, Yung Kang City (TW); Hsin-Ta Chien, Chung Li City (TW); Jui-Ping Li, San Hsing Hsiang (TW)

Correspondence Address: LOWE HAUPTMAN GOPSTEIN GILMAN & BERNER, LLP, Suite 310, 1700 Diagonal Road, Alexandria, VA, 22314, US

(73) Assignee: SILICON INTEGRATED SYSTEMS CORP.

(21) Appl. No.: 10/142,795

(22) Filed: May 13, 2002

(51) Int. Cl. G01F 23/00

(52) U.S. Cl. 73/290 R

(57) ABSTRACT

A chemical bath having liquid level indications in an outer trough is disclosed. The present invention adds an aqueduct in the outer bath of the chemical bath, and the chemical treatment liquid could flow into the aqueduct. According to the Pascal's law, the liquid level of the chemical treatment liquid in the aqueduct is the same with the liquid level of the chemical treatment liquid in the outer bath. Therefore, the level height of the chemical treatment liquid in the outer bath is observed from the transparent aqueduct by the naked eyes. The present invention abridges the complicated checkup steps, so that the producing time of apparatuses is increased and the amount of the wastes chemicals is decreased.

### FIELD OF THE INVENTION

The present invention relates to equipments used in a wet process of semiconductor, especially to the treatment equipments having liquid level indications in a wet process.

### BACKGROUND OF THE INVENTION

The wet processes used in the semiconductor manufacturing process, mainly include the wafer cleaning and the wet etching, and the apparatuses used in the wet processes are called wet benches, wherein the wet benches generally include chemical bathes, rinsing bathes, and dryer bathes. Besides, the liquid level sensors used in wet benches have two types: one is the static capacitor sensor, and the other is the N₂ level sensor. The static capacitor sensors are usually used in the chemical bathes storing chemicals which crystals are generated in or are operated in room temperature, for example, the chemicals bath storing buffer oxide etching, and the N₂ level sensor could be used in the chemical bathes of all types.

FIG. 1 illustrates a schematic diagram showing a conventional chemical treatment apparatus having the N₂ level sensor. Referring to FIG. 1, the chemical bath 10 includes an inner trough 12 and an outer trough 14, and a wafer 16 is treated in the inner trough 12 full of chemical treatment liquid 18. The chemical treatment liquid 18 flows into the inner trough 12 from pipes, and the surplus chemical treatment liquid 18 overflows into the outer trough 14 and thereafter is drained out. The surplus chemical treatment liquid 18 could be flowed through a pump 26, a heater 28 and a filter 30, and then be recycled into the inner trough 12. The height of chemical treatment liquid 18 could not be distinguished form the appearance of the convention chemical bath 10, so that the N2 level sensor is used to detect the level change of chemical treatment liquid 18 by the principle of pressure variations in bathes. For instance, when the level of chemical treatment liquid 18 is raised from a liquid level 20 to a liquid level 22, the N₂ input pressure is changed accordingly. Therefore, the pressure of chemical bath 10 or the height of chemical treatment liquid 18 can be read from a scale meter 24.

If the N₂ level sensor detects an abnormal level of chemical treatment liquid 18, an alarm is sent and all related hardware and equipments, i.e. the pump 26 or the heater 28, would be stopped and reconfirmed for safety. The interruption of hardware and equipments causes the variation in product specification. For example, the etching rate of wafer 16 would be changed and the chemicals would remains in wafer surface. Additionally, several treatment steps, such as regulating of N₂ level sensor or replacing of chemical treatment liquid, have to be performed after the apparatuses restarting.

But, according to the conventional chemical bath 10, the sizes and the amounts of bubbles in N₂ source 32 and the chemical bath 10 would affect the result detected by the N₂ level sensor. As a result, the N₂ level sensor performs the wrong action to send a false alarm. After the apparatuses restarting, the treatment steps are performed in the shutdown situation of apparatuses, and the false action would reduce the producing time of apparatuses and waste the chemical treatment liquid 18.

### SUMMARY OF THE INVENTION

In view of the conventional background, the false action of the N₂ level sensor would reduce the producing rate and waste too many chemicals. Therefore, the present invention provides a chemical bath having liquid level indications in the outer trough, so that the actual level can be easily read by the naked eye thereby increasing the stability of chemical treatment equipments.

According to the aforementioned aspects, the chemical bath having liquid level indications in the outer trough comprises: an inner trough; an outer trough connected with the inner trough, for storing a chemical treatment liquid overflowing from the inner bath; and an aqueduct connected with the outer trough, wherein a level of the chemical treatment liquid is observed from the aqueduct by naked eyes. In the chemical bath having liquid level indications in an outer trough according the present invention, the aforementioned aqueduct comprises a plurality of liquid level indications having different purposes, comprising: an over-high level indication; a circulation level indication; and an over-low level indication. Besides, the aqueduct could be composed of polyfluro-alkoxy (PFA), for composing the aqueduct having the high transparency and the resistance to the chemical treatment liquid.

According to the present invention, the chemical bath having liquid level indications in an outer trough further comprises an input pipe connecting with the inner bath for pouring the chemical treatment liquid, and an output pipe connecting with the outer bath for draining the chemical treatment liquid. In addition, a pump, a heater and a filter could be added to connect with the input pipe and the output pipe, for pumping, heating and filtering the chemical treatment liquid, then the chemical treatment liquid would be recycled to the inner bath.

The chemical bath having liquid level indications in an outer trough provided by the present invention could reduce the abnormal crashes of chemical bathes, the subsequent treatment time and the waste of chemicals, so as to improve the producing rate and yield, and decrease the cost of the semiconductor manufacture.

### BRIEF DESCRIPTION OF THE DRAWINGS

The above features of the present invention will be more clearly understood from consideration of the following descriptions in connection with accompanying drawings in which:

FIG. 1 illustrates a schematic diagram showing a conventional chemical treatment apparatus having the N₂ level sensor;

FIG. 2 illustrates the conventional flow steps used to handle an alarm of chemical treatment liquids;

FIG. 3 illustrates a schematic diagram showing a chemical treatment apparatus having the liquid level indications in an outer trough, according to the present invention; and

FIG. 4 illustrates the flow steps used to handle an alarm of chemical treatment liquids, according to the present invention.

### DETAILED DESCRIPTION OF THE PREFERRED EMBODIMENT

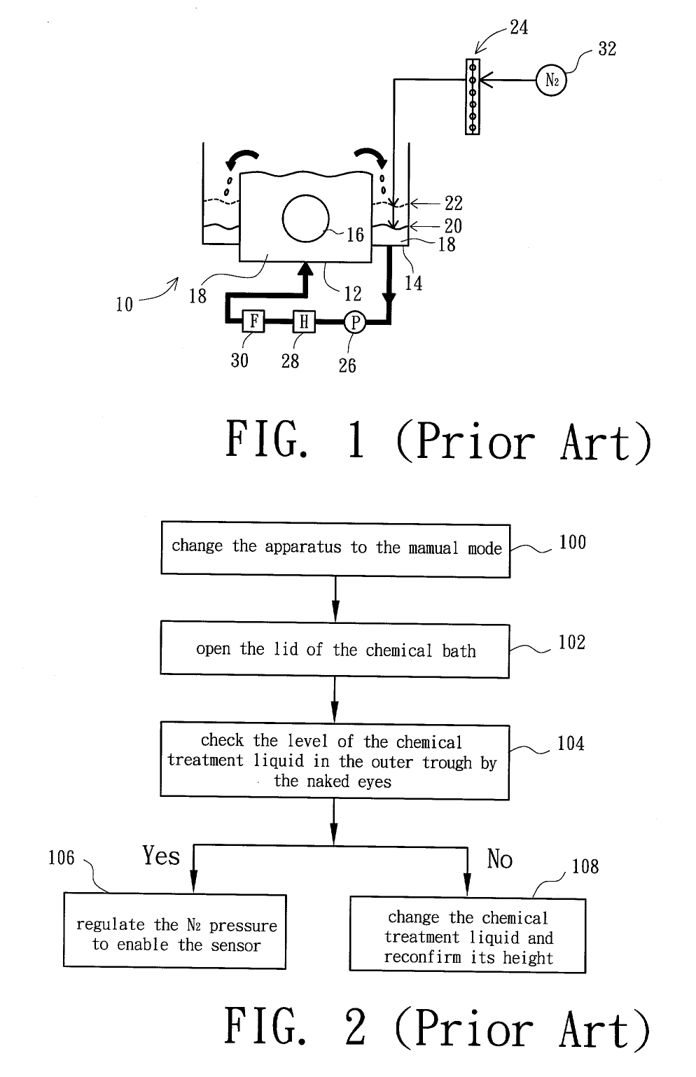

FIG. 1 illustrates a schematic diagram showing a conventional chemical treatment apparatus having the N₂ level sensor. Referring to FIG. 1, when the N₂ level sensor detects an abnormal alarm and turns off, the other equipments, as pump 26 and heater 28, are stopped accordingly, so as to prevent, under the situation having too less chemical treatment liquid in the outer trough 14 of chemical bath 10, the pump 26 and the heater 28 from working continuously and producing too high temperature, wherein such high temperature can result in the danger of the chemical treatment apparatuses, like a fire. FIG. 2 illustrates the conventional flow steps used to handle an alarm of chemical treatment liquids. Referring to FIG. 2 first, the step 100 is performed, wherein the apparatus is changed to the manual mode. Next, the step 102 and the step 104 are performed, wherein the lid of the chemical bath is opened, and the level of the chemical treatment liquid in the outer trough is checked by the naked eyes. If the level of the chemical treatment liquid in the outer trough is appropriate, then the step 106 is performed, wherein the N₂ pressure is regulated to enable the sensor. If the level of the chemical treatment liquid in the outer trough is too low, then the chemical treatment liquid is changed and reconfirmed its height.

The apparatus would be stopped to perform the aforementioned steps, for confirming the level, but it is not easy to confirm the level height from the top of the chemical bath. This cause several problems: (1) losing the using time of apparatuses; (2) increasing the shutdown hours of apparatuses; (3) increasing the time of handling abnormal problems; (4) increasing the alarm frequency resulted from abnormal levels. Therefore, the present invention provides a chemical bath having the liquid level indications to improve the aforementioned disadvantages.

FIG. 3 illustrates a schematic diagram showing a chemical treatment apparatus having the liquid level indications in an outer trough according to the present invention. Referring to FIG. 3, the chemical bath includes an inner trough 52 and an outer trough 54, wherein the chemical treatment liquid 58 is poured into the inner trough 52 from the input pipe and wafer 56 is treated in the inner trough 52 with wet process. The outer trough 54 is connected with the side of the inner trough 52. When the chemical treatment liquid 58 fills up the inner trough 52, it would overflow to the outer trough 54 and drained out by the output pipe. An aqueduct 66 is added in the outer trough 54 in the present invention, so that the chemical treatment liquid 58 would flow into the aqueduct 66. According to the Pascal's law, the level of the chemical treatment liquid 58 in the aqueduct 66 would be the same with the level of the chemical treatment liquid 58 in the outer trough 54. The material having the resistance to chemicals is used in the present invention to manufacture the transparent aqueduct 66, wherein the polyfluro-alkoxy (PFA) is preferred. Hence, the level of the chemical treatment liquid 58 is observed from the aqueduct 66 by the naked eyes.

Several liquid level indications is set on the aqueduct 66, such as the over-high level indication 68, the circulation level indication 70, and the over-low level indication 72. The over-high level indication 68 could be used to prevent the abnormal concentration during changing the chemical treatment liquid 58 of the chemical bath 50, or to protect the input pipe while the supply fails. The circulation level indication 70 could be used to confirm the liquid level of the chemical treatment liquid 58 of the chemical bath 50 after changing and before the pump 60, the heater 62 and the filter 64 starting. The over-low level indication 72 could be used to confirm the liquid level of the chemical treatment liquid 58 of the chemical bath 50 for preventing the pump 60 and the heater 62 from working unceasingly.

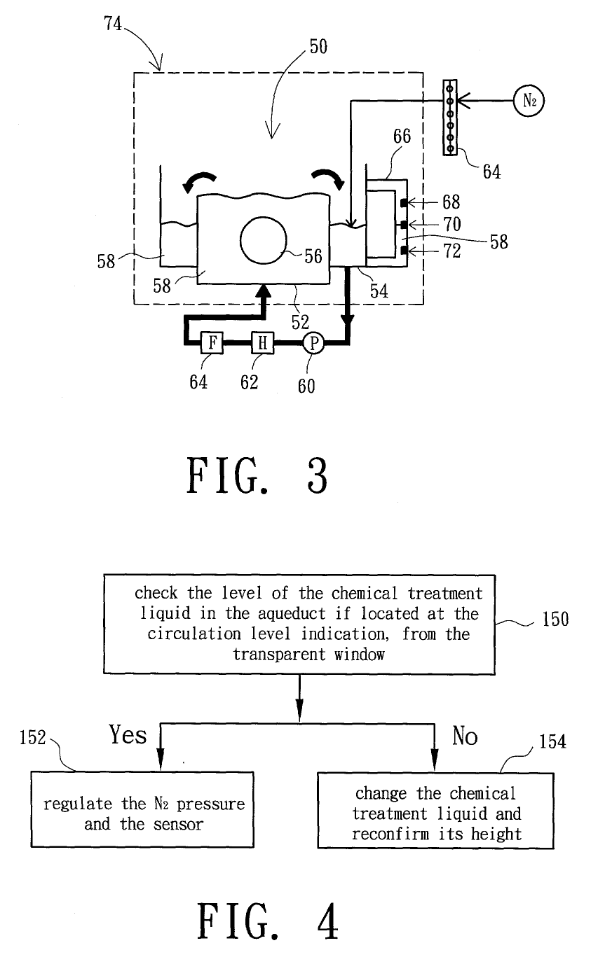

The general chemical treatment equipment has a transparent window 74 to observe the operation and the robot actions. Therefore, if the N₂ level sensor detects an abnormality and turns off, according to the present invention, the treatment steps as shown in FIG. 4 are performed. Referring to FIG. 4 first, the step 150 is performed, wherein the level of the chemical treatment liquid 58 in the aqueduct 66 is checked if located at the circulation level indication 70, from the transparent window 74. If the level of the chemical treatment liquid 58 is located on the circulation level indication 70, it is said that the N₂ level sensor has a false alarm, and then the step 152 is performed to regulate N2 pressure and the sensor. If the level of the chemical treatment liquid 58 is not located on the circulation level indication 70, it is said that the level of the chemical treatment liquid 58 had a real abnormal situation, and then the step 154 is performed to change the chemical treatment liquid 58 and reconfirm the level height.

The chemical bath having liquid level indications in an outer trough according to the present invention is not limited to connecting with the aforementioned equipments, such as pump, heater or filter, and any other equipment needed by products or processes could be added in the present invention. Besides, the chemical treatment liquid, any fluid complying with the Pascal's law, could be applied in the present invention, but the present invention is not limited thereto.

No matter when the N₂ level sensor or other kinds of sensor detect an alarm, using the chemical bath having liquid level indications in an outer trough of the present invention could distinguish the liquid level of the chemical treatment liquid in the outer bath under nonstop of apparatuses. Therefore, the convention complicated check steps would be abridged to save time. As a result of the increase of producing time, the decreases of the crashes and the waste chemicals, the producing rate of apparatuses is increased and the cost is decreased.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A chemical bath having liquid level indications in an outer trough, comprising:
an inner trough;
an outer trough connected with the inner trough, for storing a chemical treatment liquid overflowing from the inner bath; and
an aqueduct connected with the outer trough, wherein a level of the chemical treatment liquid is observed from the aqueduct by naked eyes.

2. The chemical bath having liquid level indications in an outer trough of claim 1, wherein the aqueduct comprises a plurality of liquid level indications, and the plurality of liquid level indications comprise:
an over-high level indication;
a circulation level indication; and
an over-low level indication.

3. The chemical bath having liquid level indications in an outer trough of claim 1, wherein the aqueduct is composed of polyfluro-alkoxy (PFA), for composing the aqueduct having the high transparency and the resistance to the chemical treatment liquid.

4. The chemical bath having liquid level indications in an outer trough of claim 1, further comprising an input pipe connecting with the inner bath for pouring the chemical treatment liquid, and an output pipe connecting with the outer bath for draining the chemical treatment liquid.

5. The chemical bath having liquid level indications in an outer trough of claim 1, further comprising a pump, a heater and a filter connecting with the input pipe and the output pipe, and the chemical treatment liquid drained from the output pipe is pumped by the pump, heated by the heater and filtered by the filter, and then recycled to the inner bath through the input pipe.

6. The chemical bath having liquid level indications in an outer trough of claim 1, further connecting with a N₂ level sensor for detecting the level of the chemical treatment liquid.

7. The chemical bath having liquid level indications in an outer trough of claim 1, wherein the chemical bath is used in a semiconductor process selected from a group consisting of wafer rinsing steps and wet etching steps.

8. A chemical bath having liquid level indications in an outer trough, comprising:
an inner trough having a side;
an outer trough connected with the side of the inner trough, for storing a chemical treatment liquid overflowing from the inner bath; and
an aqueduct having a plurality of level liquid level indications connected with the outer trough, wherein the chemical treatment liquid could flow into the aqueduct so as to have a same level, and the level of the chemical treatment liquid is observed from the aqueduct by naked eyes.

9. The chemical bath having liquid level indications in an outer trough of claim 8, wherein the aqueduct comprises a plurality of liquid level indications, and the plurality of liquid level indications comprise:
an over-high level indication;
a circulation level indication; and
an over-low level indication.

10. The chemical bath having liquid level indications in an outer trough of claim 8, wherein the aqueduct is composed of polyfluro-alkoxy, for composing the aqueduct having the high transparency and the resistance to the chemical treatment liquid.

11. The chemical bath having liquid level indications in an outer trough of claim 8, further comprising an input pipe connecting with the inner bath for pouring the chemical treatment liquid, and an output pipe connecting with the outer bath for draining the chemical treatment liquid.

12. The chemical bath having liquid level indications in an outer trough of claim 11, further comprising a pump, a heater and a filter connecting with the input pipe and the output pipe, and the chemical treatment liquid drained from the output pipe is pumped by the pump, heated by the heater and filtered by the filter, and then recycled to the inner bath through the input pipe.

13. The chemical bath having liquid level indications in an outer trough of claim 8, further connecting with a N₂ level sensor for detecting the level of the chemical treatment liquid.

14. The chemical bath having liquid level indications in an outer trough of claim 8, wherein the chemical bath is used in a semiconductor process selected from a group consisting of wafer rinsing steps and wet etching steps.
